(19) United States
(12) Patent Application Publication
(10) Pub. No.: US 2025/0381783 A1
(43) Pub. Date: Dec. 18, 2025

(54) DROPLET EJECTION APPARATUS, DROPLET EJECTION APPARATUS ABNORMALITY DETECTING METHOD, AND STORAGE MEDIUM

(71) Applicant: Konica Minolta, Inc., Tokyo (JP)

(72) Inventor: Kenshin SUGIMURA, Tokyo (JP)

(21) Appl. No.: 19/231,753

(22) Filed: Jun. 9, 2025

(30) Foreign Application Priority Data
Jun. 14, 2024 (JP) 2024-096719

(51) Int. Cl. B41J 2/175; B41J 2/195; G06K 15/00; G06K 15/10

(52) U.S. Cl. CPC B41J 2/17566; B41J 2/17596; B41J 2/195; G06K 15/102; G06K 15/408; B41P 2251/11

(57) ABSTRACT

A droplet ejection apparatus includes: a plurality of tanks that store a liquid; a droplet ejection head that ejects droplets; a pump that sends out the liquid stored in an upstream tank on an upstream side in a liquid delivery direction to a downstream tank on a downstream side in the liquid delivery direction; a liquid channel that communicates the upstream tank and the downstream tank; a measurer that measures a value related to a liquid amount of the liquid in the downstream tank; and a hardware processor. The hardware processor determines whether there is an abnormality in the liquid channel. The hardware processor determines whether there is an abnormality in the liquid channel based on a change in a value related to the liquid amount in the downstream tank when the pump sends out the liquid for a predetermined liquid delivery time.

### CROSS-REFERENCE TO RELATED APPLICATIONS

The entire disclosure of Japanese Patent Application No. 2024-096719, filed on Jun. 14, 2024, is incorporated herein by reference in its entirety.

### BACKGROUND OF THE INVENTION

### Technical Field

The present invention relates to a droplet ejection apparatus, a droplet ejection apparatus abnormality detecting method, and a storage medium.

### Description of Related Art

Conventionally, a droplet ejection apparatus that ejects droplets from a droplet ejection head is known. Such droplet ejection apparatus includes a plurality of tanks containing liquid, and sends the liquid to a droplet ejection head by a pump.

However, as the droplet ejection apparatus is repeatedly driven, an abnormality such as clogging occurs in the liquid channel due to a component in the liquid. If the abnormality occurs in the liquid channel, a flow rate of the liquid relatively decreases, and the droplet ejection apparatus stops functioning. Therefore, it is necessary to detect an abnormality of the liquid channel and perform maintenance.

Therefore, for example, Japanese Unexamined Patent Publication No. 2011-201234 describes a method in which liquid is fed by a pump to a tank in which it is possible to measure a liquid level height, and a time required for the liquid level to reach a second liquid level height from a first liquid level height is measured, thereby detecting the abnormality in the liquid channel located upstream in a liquid delivery direction of the tank.

However, when the liquid amount is changed, the liquid level shakes, and thus it may not be possible to accurately detect that the liquid level has reached the second liquid level height. In addition, in particular, in a case where the flow rate of the pump is high, the liquid level height may become higher than the second liquid level height due to a time lag from the detection of the second liquid level height and the transmission of a liquid delivery stop signal to the actual stop of the liquid delivery by the pump. Therefore, abnormality of the liquid channel cannot be detected with high accuracy by the above-described method.

### SUMMARY OF THE INVENTION

The present invention has been made in view of such circumstances. An object of the present invention is to provide a droplet ejection apparatus capable of detecting an abnormality of a liquid channel with high accuracy, an abnormality detection method for the droplet ejection apparatus, and a storage medium.

In order to solve the above-described problem, according to an aspect of the present invention, a droplet ejection apparatus reflecting one aspect of the present invention includes,
a plurality of tanks that store a liquid;
a droplet ejection head that ejects droplets;
a pump that sends out the liquid stored in an upstream tank on an upstream side in a liquid delivery direction to a downstream tank on a downstream side in the liquid delivery direction;
a liquid channel that communicates the upstream tank and the downstream tank;
a measurer that measures a value related to a liquid amount of the liquid in the downstream tank; and
a hardware processor, wherein,
the hardware processor determines whether there is an abnormality in the liquid channel, and
the hardware processor determines whether there is an abnormality in the liquid channel based on a change in a value related to the liquid amount in the downstream tank when the pump sends out the liquid for a predetermined liquid delivery time.

According to another aspect, a droplet ejection apparatus abnormality detecting method executed by a droplet ejection apparatus including,
a plurality of tanks that store a liquid,
a droplet ejection head that ejects droplets,
a pump that sends out the liquid stored in an upstream tank on an upstream side in a liquid delivery direction to a downstream tank on a downstream side in the liquid delivery direction,
a liquid channel that communicates the upstream tank and the downstream tank, and
a measurer that measures a value related to a liquid amount of the liquid in the downstream tank,
the method including:
determining whether there is an abnormality in the liquid channel,
wherein it is determined whether there is an abnormality in the liquid channel based on a change in a value related to the liquid amount in the downstream tank when the pump sends out the liquid for a predetermined liquid delivery time.

According to another aspect, a non-transitory computer readable storage medium storing a program executed in a computer in a droplet ejection apparatus including,
a plurality of tanks that store a liquid,
a droplet ejection head that ejects droplets,
a pump that sends out the liquid stored in an upstream tank on an upstream side in a liquid delivery direction to a downstream tank on a downstream side in the liquid delivery direction,
a liquid channel that communicates the upstream tank and the downstream tank, and
a measurer that measures a value related to a liquid amount of the liquid in the downstream tank,
the program causing the computer to perform,
determining whether there is an abnormality in the liquid channel,
wherein it is determined whether there is an abnormality in the liquid channel based on a change in a value related to the liquid amount in the downstream tank when the pump sends out the liquid for a predetermined liquid delivery time.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a cross-sectional side view of an inkjet recording apparatus;

FIG. 2 is a schematic configuration diagram of a liquid delivery section;

FIG. 3 is a schematic cross-sectional view of a liquid level sensor and a sub-tank;

FIG. 4 is a block diagram of the inkjet recording apparatus;

FIG. 5 is a flowchart of a liquid channel clogging detecting process; and

FIG. 6 is a diagram illustrating an increase in the liquid level height in the second sub-tank in the liquid channel clogging detecting process.

### DETAILED DESCRIPTION

Hereinafter, one or more embodiments of the present invention will be described with reference to the drawings. However, the scope of the invention is not limited to the disclosed embodiments.

Hereinafter, a droplet ejection apparatus according to an embodiment of the present invention will be described in detail with reference to the drawings. However, the scope of the invention is not limited to the illustrated examples. In the following description, components having the same function and configurations are denoted by the same reference numerals, and the description thereof will be omitted.

### [Overall Configuration of Inkjet Recording Apparatus]

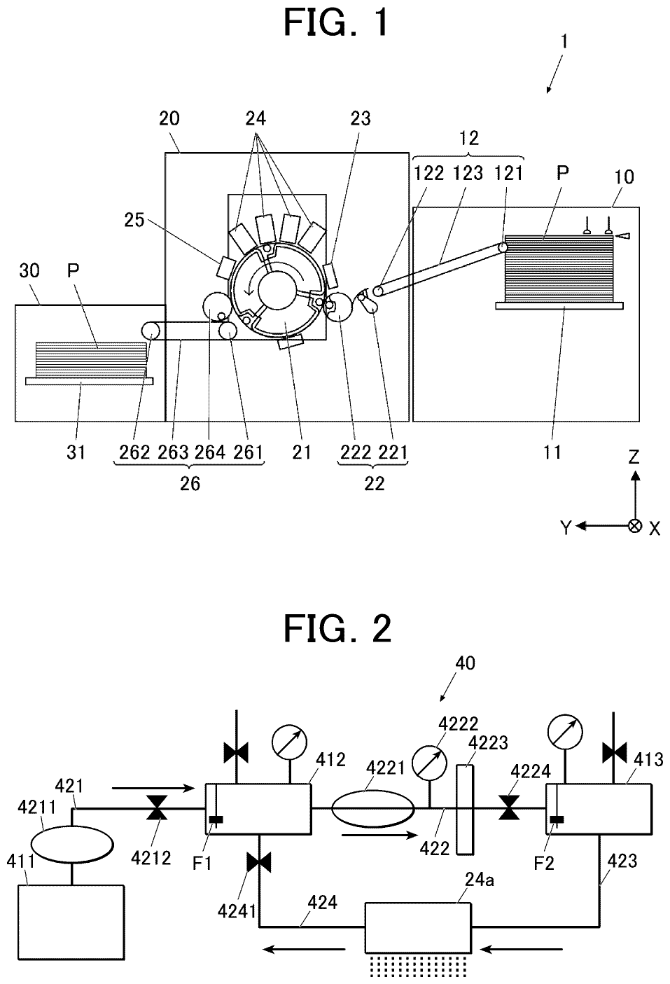

FIG. 1 is a cross-sectional side view of a main configuration of an inkjet recording apparatus 1 as an embodiment of a liquid droplet ejection apparatus of the present invention. The inkjet recording apparatus 1 includes a sheet feed section 10, an image forming section 20, a sheet ejection section 30, a liquid delivery section 40 (liquid deliverer) (see FIG. 2), a controller (hardware processor) 50 (see FIG. 4) and a notification section 60 (see FIG. 4).

The inkjet recording apparatus 1 conveys the recording medium P from the sheet feed section 10 to the image forming section 20 under the control of the controller 50. The controller 50 then causes the image forming section 20 to form images on the recording medium P with the ink supplied by the liquid delivery section 40. After image formation, the controller 50 ejects the recording medium P to the sheet ejection section 30.

Note that the recording medium P is not limited to paper such as plain paper and coated paper. As the recording medium P, various media capable of fixing the ink landed on the surface thereof, such as a textile or a sheet-shaped resin, can be used.

Note that in the following, an X direction, a Y direction, and a Z direction are directions illustrated in FIG. 1. In the following description, the X direction, the Y direction, and the Z direction are also referred to as a width direction, a conveyance direction, and a height direction, respectively.

### (Sheet Feed Section)

The sheet feed section 10 stores a recording medium P before image formation. The sheet feed section 10 conveys the recording medium P to the image forming section 20 under the control of the controller 50. The sheet feed section 10 includes a sheet feed tray 11 and a conveyance section 12.

### {Sheet Feed Tray}

The sheet feed tray 11 is a plate member that stores the recording medium P. The sheet feed tray 11 is provided such that one or a plurality of recording medium P can be placed thereon. The sheet feed tray 11 is moved upward and downward according to an amount of the recording medium P placed thereon. By the upward and downward movements, the sheet feed tray 11 is kept such that an uppermost recording medium P is conveyed by the conveyance section 12.

### {Conveyance Section}

The conveyance section 12 conveys the recording medium P from the sheet feed tray 11 to the image forming section 20. The conveyance section 12 includes a conveyance mechanism. The conveyance mechanism drives a belt 123 to convey the recording medium P on the belt 123. The belt 123 has a ring shape, and the inner side of the ring is supported by a plurality of rollers 121 and 122. The conveyance section 12 delivers the uppermost recording medium P placed on the sheet feed tray 11 onto the belt 123, and conveys the recording medium P along the belt 123.

### (Image Forming Section)

The image forming section 20 records an image on the recording medium P in cooperation with the liquid delivery section 40 under the control of the controller 50. The image forming section 20 includes an image forming drum 21, a handover unit 22, a sheet heating section 23, a head unit 24, an irradiation section 25, and a delivery section 26.

### {Image Forming Drum}

The image forming drum 21 holds the recording medium P along its cylindrical outer periphery surface and rotates to convey the recording medium P. The conveyance surface of the image forming drum 21 faces the sheet heating section 23, the head unit 24, and the irradiation section 25, which perform image formation processing on the conveyed recording medium P.

### {Handover Unit}

The handover unit 22 is provided between the conveyance section 12 and the image forming drum 21. The handover unit 22 includes a claw 221 and a handover drum 222.

The claw 221 is a cylindrical part that holds one end of the recording medium P conveyed by the conveyance section 12. The handover drum 222 guides the recording medium P held by the claw 221.

The handover unit 22 picks up the recording medium P on the conveyance section 12 with the claw 221 and places the recording medium P along the outer periphery surface of the handover drum 222. Thus, the handover unit 22 passes the recording medium P to the image forming drum 21.

### {Sheet Heating Section}

The sheet heating section 23 includes, for example, a heating wire and generates heat by energization. The sheet heating section 23 is controlled by the controller 50 to generate heat so that the recording medium P passing in the vicinity of the sheet heating section 23 has a predetermined temperature. The sheet heating section 23 is provided in the vicinity of the outer periphery surface of the image forming drum 21 and on the upstream side of the head unit 24 in the conveyance direction of the recording medium P.

A temperature sensor (not illustrated) is provided near the sheet heating section 23. With the temperature sensor, the controller 50 detects the temperature around the sheet heating section 23. Based on the detected temperature, the controller 50 controls heat generation of the sheet heating section 23.

### {Head Unit}

The head unit 24 is constituted by a plurality of inkjet heads. The head unit 24 ejects ink droplets from nozzles onto the recording medium P to form the image. The head units 24 corresponding to the colors of C (cyan),

M (magenta), Y (yellow), and K (black) are provided. In FIG. 1, the head units 24 corresponding to the colors of Y, M, C, and K are provided in this order from the upstream of the conveyance direction of the recording medium P. A plurality of head units 24 according to the present embodiment are arranged so as to be in a length (width) that covers the entire width of the recording medium P in the width direction. That is, the inkjet recording apparatus 1 is a one-pass line-head type inkjet recording apparatus. Each of the head units 24 includes an array of a plurality of inkjet heads 24a (see FIG. 2), which are droplet ejection heads. The number of the head unit 24 may be five or more or three or less. Further, one inkjet head 24a may constitute one head unit 24.

The ink jetted by the head unit 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium P.

The ink ejected by the head unit 24 may be ink containing a gelling agent. The ink containing the gelling agent changes in phase between a gel state and a liquid (sol) state depending on the temperature. The ink containing the gelling agent has a phase change temperature of, for example, about 40 to 100° C., and is uniformly liquefied (solated) by being heated to the phase change temperature or higher. On the other hand, the ink containing the gelling agent is gelled at about normal room temperature, that is, about 0 to 30° C. Therefore, the ink in the head unit 24 is heated to an appropriate temperature by an ink heater or the like (not illustrated) to be brought into a sol state. Then, after being ejected and landed on the recording medium P, the ink is moderately transferred to a gel state while being conveyed by the image forming drum 21.

### {Irradiation Section}

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided in the vicinity of the outer periphery surface of the image forming drum 21. The irradiation section 25 is positioned downstream of the head unit 24 in the conveyance direction of the recording medium P. The irradiation section 25 emits energy rays to the recording medium P on which the ink has been ejected. When the ink on the recording medium P is UV ink, the ink is cured by the action of the energy rays.

The fluorescent tube that emits ultraviolet rays is not limited to a low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet light with higher illuminance. The fluorescent tube is, for example, a light emission diode. The energy rays are not limited to the ultraviolet rays and may be energy rays having a property of curing the ink depending on the property of the ink. The light source is determined depending on the energy rays.

In the above description, the case where the head unit 24 discharges the ultraviolet curable ink or the ink containing the gelling agent is exemplified, but the invention is not limited thereto. The ink ejected by the head unit 24 may be water-based ink or ink having other physical properties.

### {Delivery Section}

The delivery section 26 includes a conveyance mechanism. The conveyance mechanism drives a ring shaped belt 263 to convey the recording medium P. The inner side of the belt 263 is supported by a plurality of rollers 261 and 262. The delivery section 26 includes a cylindrical roller 264. The handover roller 264 passes the recording medium P from the image forming drum 21 to the conveyance mechanism. The delivery section 26 conveys and sends the recording medium P passed on the belt 263 by the handover roller 264 to the sheet ejection section 30.

### (Sheet Ejection Section)

The recording medium P on which the image is formed by the image forming section 20 is ejected to the sheet ejection section 30. The sheet ejection section 30 includes a plate-shaped sheet ejection tray 31. The recording medium P sent out from the image forming section 20 by the delivery section 26 is placed on the sheet ejection tray 31. The sheet ejection section 30 stores the recording medium P until a user takes out the recording medium P.

### (Liquid Delivery Section)

FIG. 2 shows a schematic configuration of the liquid delivery section 40. FIG. 2 shows only one inkjet head 24a, and other plurality of inkjet heads 24a are omitted. The liquid delivery section 40 includes a tank 41, a liquid channel 42, and the like (see FIG. 4 showing both).

### {Tank}

The tank 41 stores ink therein. The tank 41 is made of, for example, metal, and has a rigid sealed structure. The tank 41 includes a main tank 411, a first sub-tank 412, and a second sub-tank 413.

### [Main Tank]

The main tank 411 stores each color ink to be supplied to each portion of the liquid delivery section 40. Although omitted in FIG. 2, the main tank 411 is provided individually for each color of ink. The ink is supplied to an inkjet head 24 via a first liquid channel 421, the first sub-tank 412, a second liquid channel 422, the second sub-tank 413, and a third liquid channel 423, which will be described later. The entire body of the main tank 411 is replaceable, and the main tank 411 is formed so as to be attachable to and detachable from the first liquid channel 421 regardless of the operating status of a supply pump 4211 which will be described later.

### [First Sub-Tank]

The first sub-tank 412 temporarily stores the ink supplied from the main tank 411. Since the liquid delivery section 40 includes the first sub-tank 412, a pressure change due to pulsation when the supply pump 4211 supplies the ink of the main tank 411 is alleviated. The ink that is not discharged from the inkjet head 24a is collected to the first sub-tank 412 from an outlet.

### [Second Sub-Tank]

The second sub-tank 413 temporarily stores the ink from which foreign substances have been collected by a filter 4223 which will be described later. The second sub-tank 413 is provided with a back pressure adjustment means (not illustrated). The back pressure adjustment means applies appropriate negative pressure to the inkjet head 24a to prevent ink from leaking out of the inkjet head 24a.

Note that in the following description, the first sub-tank 412 and the second sub-tank 413 will be simply referred to as “sub-tank” unless otherwise distinguished from each other.

### <Liquid Level Sensor>

The sub-tanks are each provided with a liquid level sensor F (measurer). The liquid level sensor F measures information on the amount of ink in the attached sub-tank. Specifically, the liquid level sensor F measures a liquid level position in the sub-tank and transmits the data to the controller 50. The controller 50 acquires a liquid level height in the sub-tank based on the data.

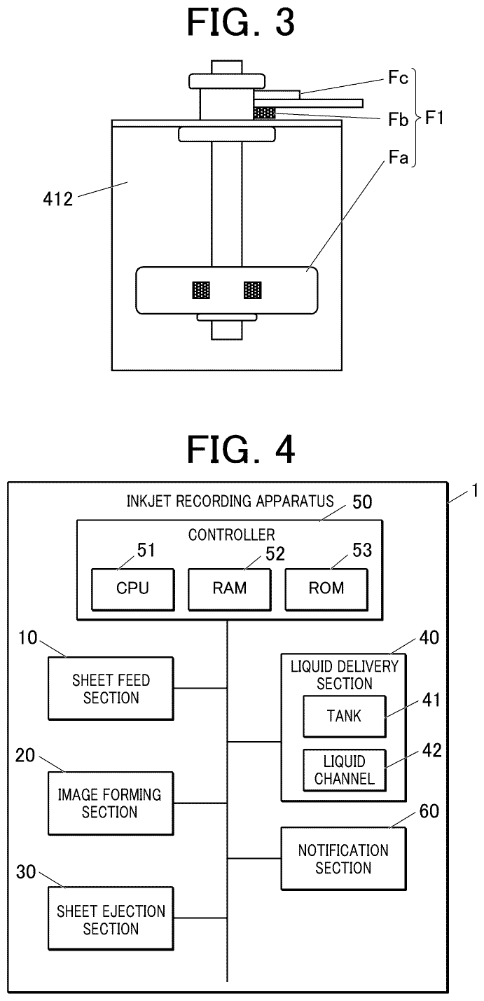

A detailed configuration of the liquid level sensor F according to the present embodiment is illustrated in FIG. 3. As illustrated in FIG. 3, for example, the liquid level sensor F is a float sensor including a float Fa, a sensor Fb, and a magnetic body Fc.

The float Fa is provided in the sub-tank. A magnet is built in the float Fa. The float Fa moves up and down in accordance with an increase or decrease of the ink in the sub-tank to generate a magnetic field. The magnetic sensor Fb is provided at the top of the sub-tank. The magnetic sensor Fb measures a magnetic flux density of the magnetic field that changes according to whether the float Fa moves up or down. The magnetic sensor Fb measures the liquid level height in the sub-tank. The magnetic body Fc is provided in the vicinity of the magnetic sensor Fb. The magnetic body Fc concentrates the magnetic flux on the sensor Fb, thereby improving the sensitivity thereof. As described above, the liquid level sensor F according to the present embodiment is a magnetic sensor that measures information on the amount of ink by magnetism.

The magnetic sensor Fb may be provided on a side surface portion of the sub-tank. However, it is preferable to provide the magnetic sensor Fb at an upper part of the sub-tank because its sensitivity is improved.

Furthermore, the liquid level sensor F for measuring the liquid level height in the sub-tank is not limited to the float sensor including the float Fa and the magnetic sensor Fb. For example, the liquid level height in the sub-tank may be measured by a capacity sensor using an electric field.

Furthermore, although the first sub-tank 412 is illustrated in FIG. 3, the liquid level sensor F is also attached to the second sub-tank 413 in a similar manner. Hereinafter, for distinction, the liquid level sensor F provided in the first sub-tank 412 will be described as a first liquid level sensor F1, and the liquid level sensor F provided in the second sub-tank 413 will be described as a second liquid level sensor F2.

The sub-tank is provided with an ink heating section (not illustrated) that holds the ink therein at an appropriate temperature. The ink heating section is constituted of a heater, a heat transfer member that transfers heat of the heater, and the like. As the heater constituting the ink heating section, a heating wire that generates Joule heat by energization is used, for example. As the heat transfer member constituting the ink heating section, a member having a high heat conductivity, such as a heat conductive plate formed of various metals (alloys) is used, for example.

In addition, the sub-tank is provided with a pressure sensor capable of measuring an internal pressure value and a ventilation path which communicates with the atmosphere. The ventilation path is provided with a pneumatic pump capable of sucking and depressurizing the air in each sub-tank under the control of the controller 50, and the pressure in each sub-tank is controlled.

In particular, the controller 50 makes the pressure in the first sub-tank 412 higher than the pressure in the second sub-tank 413 by, for example, sending air from the second sub-tank 413 to the first sub-tank 412, and sends the ink in the first sub-tank 412 to the second sub-tank 413. More specifically, in a state where the liquid amount in the first sub-tank 412 is larger than a predetermined lower limit value, when the liquid amount in the second sub-tank 413 reaches a predetermined lower limit value, the ink in the first sub-tank 412 is delivered to the second sub-tank 413 by the above-described control by the controller 50.

Furthermore, aside from the second liquid channel 422, a channel that provides communication between the first sub-tank 412 and the second sub-tank 413 may be provided. Then, the pressure in the second sub-tank 413 may be made higher than the pressure in the first sub-tank 412 to circulate the ink in the second sub-tank 413 to the first sub-tank 412 via the channel.

### {Liquid Channel}

The liquid channel 42 is an ink channel that communicates from the main tank 411 to the inkjet head 24a so as to enable a return flow. The liquid channel 42 includes the first liquid channel 421, the second liquid channel 422, the third liquid channel 423, and the fourth liquid channel 424. The liquid channel 42 preferably has ink resistance, and has a hollow annular tube structure.

### [First Liquid Channel]

The first liquid channel 421 allows the main tank 411 and the first sub-tank 412 to communicate with each other. The first liquid channel 421 is provided with a supply pump 4211 and a supply valve 4212.

### <Supply Pump>

The supply pump 4211 delivers the ink in the main tank 411 to the first sub-tank 412. If the controller 50 detects, as a result of the measurement by the first liquid level sensor F1, that the liquid amount in the first sub-tank 412 is the predetermined lower limit value, the controller 50 drives the supply pump 4211 for a predetermined amount of time to deliver the ink in the main tank 411 to the first sub-tank 412.

The supply pump 4211 is preferably a diaphragm pump in terms of durability, cost, size, abundance of types, and the like.

### <Supply Valve>

The supply valve 4212 is, for example, an electromagnetic valve. Under the control of the controller 50, the supply valve 4212 selectively opens the first liquid channel 421 when the supply pump 4211 is driven.

### [Second Liquid Channel]

The second liquid channel 422 is a channel that allows the first sub-tank 412 and the second sub-tank 413 to communicate with each other. The second liquid channel 422 is provided with a circulation pump 4221, a pressure sensor 4222, a filter 4223, and a first circulation valve 4224.

### <Circulation Pump>

The circulation pump 4221 delivers the ink in the first sub-tank 412 to the second sub-tank 413. If the controller 50 detects, as a result of measurement by the second liquid level sensor F2, that the liquid amount in the second sub-tank 413 is the predetermined lower limit value, the controller 50 drives the circulation pump 4221 for a predetermined amount of time to deliver the ink in the first sub-tank 412. For the same reason as the supply pump 4211, the circulation pump 4221 is preferably a diaphragm pump.

### <Pressure Sensor, Filter, First Circulation Valve>

The pressure sensor 4222 detects a pressure value of the second liquid channel 422 and transmits the pressure value to the controller 50. The filter 4223 is formed of, for example, a mesh-like metal or resin porous body or the like, and has a mesh of a predetermined size. The filter 4223 collects the foreign substances in the ink flowing through the second liquid channel 422. The first circulation valve 4224 is the electromagnetic valve, and selectively opens the second liquid channel 422 when the circulation pump 4221 is driven.

### [Third Liquid Channel and Fourth Liquid Channel]

The third liquid channel 423 is a channel that communicates between the second sub-tank 413 and an inlet of the inkjet head 24a. In addition, the fourth liquid channel 424 is a channel that allows the outlet of the inkjet head 24 and the first sub-tank 412 to communicate with each other. The fourth liquid channel 424 is provided with a second circulation valve 4241 which is an electromagnetic valve. The second circulation valve 4241 selectively opens the fourth liquid channel 424 when the ink is circulated from the inkjet head 24 to the first sub-tank 412, under the control of the controller 50.

### (Controller)

FIG. 4 is a block diagram illustrating a configuration of the inkjet recording apparatus 1. The controller 50 controls each section constituting the inkjet recording apparatus 1. As shown in FIG. 4, the controller 50 is connected to each section constituting the inkjet recording apparatus 1. The controller 50 includes a central processing unit (CPU) 51, a random access memory (RAM) 52, and a read only memory (ROM) 53.

The CPU 51 reads various programs and data corresponding to processing contents from the storage device of the ROM 53 or the like and executes them. Further, the CPU 51 controls the operation of the components constituting the inkjet recording apparatus 1 according to the contents of the executed processing. The RAM 52 temporarily stores therein the various programs and program processed by the CPU 51. The ROM 53 stores various programs and data, which are read by the CPU 51 or the like.

### (Notification Section)

The notification section 60 provides notification of various types of information under the control of the controller 50. The notification section 60 is, for example, a display part having a screen, a communication section capable of communicating with another device via a network, or the like.

### [Pump Flow Rate Measurement Processing]

Pump flow rate measurement processing and liquid channel clogging detecting processing by the inkjet recording apparatus 1 as described above will be described. Prior to the liquid channel clogging detecting processing, the controller 50 executes the pump flow rate measurement processing.

The controller 50 causes the circulation pump 4221 to deliver the liquid for a predetermined liquid delivery time S1 [s]. Next, it is assumed that, as a result of the measurement by the second liquid level sensor F2, the liquid level height in the second sub-tank 413 has risen by L1 [mm]. At this time, the controller 50 calculates a flow rate V1 [mm/s] per unit time of the circulation pump 4221 by the following formula (1).

$$V 1 [ mm / s ] = L 1 [ mm ] / S 1 [ s ] \qquad Formula ( 1 )$$

The controller 50 stores the calculated flow rate V1 of the circulation pump 4221 in the ROM 53, and ends the pump flow rate measurement processing.

Note that the execution timing of the pump flow rate measurement processing is particularly preferably the time of installation of the inkjet recording apparatus 1. At the time of installation of the inkjet recording apparatus 1, the clogging of the liquid channel 42 is smallest, and the maximum flow rate can be acquired. Therefore, in the liquid channel clogging detecting processing which will be described later, it becomes clearer whether the clogging occurs in the liquid channel 42 and the flow rate decreases.

### [Liquid Channel Clogging Detecting Processing]

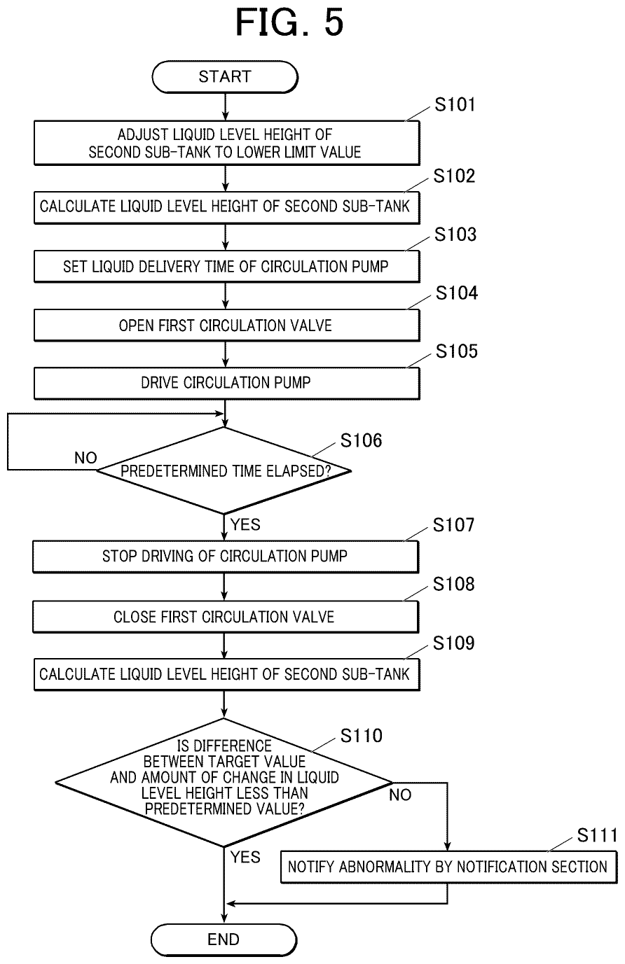

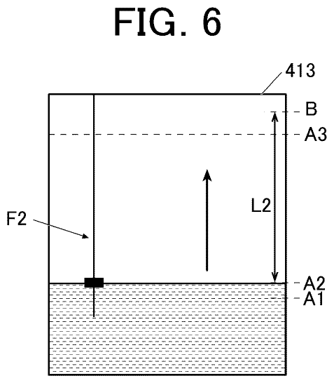

Next, liquid channel clogging detecting processing by the inkjet recording apparatus 1 as described above will be described with reference to the flowchart of FIG. 5 and FIG. 6. The controller 50 executes the liquid channel clogging detecting process at a predetermined timing, for example, after a predetermined number of image forming processes or when the inkjet recording apparatus 1 is activated. In addition, hereinafter, it is assumed that the presence or absence of clogging of the second liquid channel 422, in particular, the filter 4223 is detected.

First, the controller 50 adjusts the liquid level height in the second sub-tank 413, which is the tank 41 on the downstream side in the liquid delivery direction of the second liquid channel 422 that is the liquid channel 42 subject to abnormality detection, to the lower limit value A1 of the liquid level height in the second sub-tank 413 (step S101). In a case where the liquid level height in the second sub-tank 413 is higher than the lower limit value A1, the controller 50 adjusts the pressure in the second sub-tank 413 by the back-pressure adjustment means. Through the above-described control, the controller 50 performs adjustment to discharge the ink in the second sub-tank 413 and to lower the liquid level height in the second sub-tank 413. In this way, the controller 50 functions as an adjustment section to adjust the liquid level height in the second sub-tank 413 to a predetermined value before step S105.

The controller 50 acquires the measurement value of the second liquid level sensor F2 for a predetermined amount of time (for example, 10 seconds). Next, the controller 50 calculates a first liquid level height A2 of the second sub-tank 413 from a mean value of the measurement values (step S102). Since the liquid level height of the second sub-tank 413 is changed in step S101, the liquid level of the liquid in the second sub-tank 413 shakes. Therefore, one measurement value of the second liquid level sensor F2 acquired at a predetermined timing has low accuracy as the liquid level height of the second sub-tank 413. However, as described above, by causing the controller 50 to function as a calculation section which calculates the first liquid level height A2 based on the mean value of the measurement values of the second liquid level sensor F2 for a predetermined amount of time, it is possible to acquire the first liquid level height A2 with high accuracy.

The controller 50 sets the liquid delivery time S2 of the circulation pump 4221 in the subsequent step S105 (step S103). The liquid delivery time S2 can be calculated by the following formula (2) based on the flow rate V1 [mm/s] of the circulation pump 4221 calculated in the pump flow rate measurement processing and a liquid level rise value L2 [mm] of the second sub-tank 413 which is a target value.

$$S 2 [ s ] = L 2 [ mm ] / V 1 [ mm / s ] \qquad Formula ( 2 )$$

Note that the target value L2 is sufficient if A2+L2 is equal to or less than the upper limit B of the liquid level height in the second sub-tank 413. Provided that the target value L2 is preferably a value satisfying A2+L2=B, in other words, L2=B−A2. When the liquid level height of the second sub-tank 413 is set to the lower limit value A1 in step S101 and then the target value L2 is set to satisfy L2=B−A2, the liquid delivery time S2 becomes the longest. Therefore, in step S110 which will be described later, a difference between L2−(A3−A2) and a predetermined value is more likely to occur, and the presence or absence of clogging in the second liquid channel 422 becomes clearer.

In this way, the controller 50 functions as a setting section that sets the liquid delivery time S2 in step S104 based on the flow rate V1 of the circulation pump 4221 calculated in advance in the pump flow rate measurement processing.

The controller 50 sets the first circulation valve 4224 to an open state (step S104). Then, the controller 50 drives the circulation pump 4221 for the liquid delivery time step S2 set in step S103 to deliver the liquid to the second sub-tank 413 (step S105). After the predetermined amount of time has elapsed (step S106; Yes), the controller 50 stops driving the circulation pump 4221 (step S107) and closes the first circulating valve 4224 (step S108).

The controller 50 acquires the measurement value of the second liquid level sensor F2 for a predetermined amount of time (for example, 10 seconds). Then, the mean value of the measurement values is calculated (step S109). Similarly to step S102, the liquid level of the liquid in the second sub-tank 413 shakes due to the change in the liquid level height of the second sub-tank 413. However, by acquiring the mean value of the measurement value of the second liquid level sensor F2 for the predetermined amount of time in this way, a highly accurate second liquid level height A3 can be acquired.

The controller 50 determines whether a difference between the target value L2 and the amount of change A3−A2 in the liquid level height is less than a predetermined value (step S110). When the value of L2−(A3−A2) is less than the predetermined value (step S110; Yes), that is, when the amount of ink having a value close to the target value L2 can be delivered, the controller 50 determines that there is no abnormality in the second liquid channel 422, and ends the liquid channel clogging detecting processing. On the other hand, when the value of L2−(A3−A2) is equal to or more than the predetermined value (step S110; No), that is, when the amount of ink having a value close to the target value L2 cannot be delivered, the controller 50 determines that the second liquid channel 422 has abnormality. Therefore, the controller 50 notifies the user of a warning by the notification section 60 (step S111). In this manner, the controller 50 functions as a determination section to determine the presence or absence of abnormality in the liquid channel 42.

### Effects of Embodiment

As described above, the inkjet recording apparatus 1 according to the present embodiment includes a plurality of tanks 41 storing liquid. The inkjet recording apparatus 1 further includes a droplet ejection head 24a to eject droplets. The inkjet recording apparatus 1 further includes a pump that sends out the liquid stored in the upstream tank on the upstream side in the liquid feeding direction to the downstream tank on the downstream side in the liquid delivery direction. The inkjet recording apparatus 1 further includes a liquid channel 42 that provides communication between the upstream tank and the downstream tank. Furthermore, the inkjet recording apparatus 1 includes a liquid level sensor F which functions as a measurement section for measuring a value related to the liquid amount of the liquid in the downstream tank. In addition, the inkjet recording apparatus 1 is provided with the controller 50 which functions as a determination section which determines the presence or absence of an abnormality in the liquid channel 42 based on a change in a value relating to the liquid amount of the downstream tank when the liquid is sent out by the pump for a predetermined liquid delivery time. According to the above configuration, unlike the case where the liquid is delivered so as to have a predetermined liquid level height, the liquid delivery time for achieving the predetermined liquid level height is set in advance. Therefore, the presence or absence of abnormality of the liquid channel can be detected with high accuracy.

### Modification Example and the Like

Although specific descriptions have been given above on the basis of the embodiment according to the present invention, the present invention is not limited to the above-described embodiment. The present invention can be subjected to various modifications within the scope of the invention described in the claims and the equivalents thereof.

For example, although the configuration in which whether clogging occurs in the second liquid channel 422 is detected has been illustrated in the above description, it is not limited thereto. Any liquid channel 42 can be subjected to abnormality detection provided that the liquid channel 42 includes a pump and the tank 41 on the upstream side in the liquid delivery direction and includes the tank 41 on the downstream side in the liquid delivery direction. Therefore, in the present embodiment, the first liquid channel 421 that includes the main tank 411 and the supply pump 4211 on the upstream side in the liquid delivery direction and includes the first sub-tank 412 on the downstream side in the liquid delivery direction can also be the target of the liquid channel clogging detecting processing.

In the above description, in step S101, the liquid level height in the second sub-tank 413 is adjusted to the lower limit value A1 of the liquid level height in the second sub-tank 413, but the present invention is not limited thereto. In step S101, it is sufficient to set the liquid level height in the second sub-tank 413 to a certain predetermined value, and the predetermined value is not limited to the lower limit value A1. Note that, for example, in a case where the current liquid level height in the second sub-tank 413 is the lower limit value A1 and the predetermined value is greater than or equal to the lower limit value A1, ink may be delivered from the first sub-tank 412 to the second sub-tank 413.

Furthermore, although it is preferable to set the target value L2 such that L2=B−A2 in step S103 in the description above, it is not limited thereto. However, as a result of the liquid delivery of step S106, in a case where the second liquid level height A3 of the second sub-tank 413 exceeds the upper limit value B, there is a risk that the ink overflows from the second sub-tank 413. Therefore, in a case where the measurement accuracy of the second liquid level sensor F2 is low, it is preferable to appropriately set the target value L2 such that L2<B−A2.

In addition, in the above description, a configuration in which the liquid channel 42 is a circulation channel is exemplified, but the invention is not limited thereto. That is, even in a case where the liquid channel 42 is not provided with the fourth liquid flow path 424 which communicates the outlet of the inkjet head 24a and the first sub-tank 412, the configuration of the present invention can be applied.

Further, although the droplet ejection apparatus is the inkjet recording apparatus 1 in the above embodiment, the invention is not limited thereto. That is, the liquid ejected by the droplet ejection apparatus is not limited to ink, but may be, for example, water or a predetermined pretreatment liquid.

In the above description, an example in which a hard disk, a semiconductor non-volatile memory, or the like is used as a computer-readable medium for the program according to the present invention has been disclosed, but the medium is not limited to this example. As another computer-readable medium, a portable recording medium such as a CD-ROM can be applied. Furthermore, a carrier wave is also applied as a medium for providing data of the program according to the present invention via a communication line.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2024-096719, filed on Jun. 14, 2024, including description, claims, drawings and abstract is incorporated herein by reference.

What is claimed is:

1. A droplet ejection apparatus comprising:
a plurality of tanks that store a liquid;
a droplet ejection head that ejects droplets;
a pump that sends out the liquid stored in an upstream tank on an upstream side in a liquid delivery direction to a downstream tank on a downstream side in the liquid delivery direction;
a liquid channel that communicates the upstream tank and the downstream tank;
a measurer that measures a value related to a liquid amount of the liquid in the downstream tank; and
a hardware processor, wherein,
the hardware processor determines whether there is an abnormality in the liquid channel, and the hardware processor determines whether there is an abnormality in the liquid channel based on a change in a value related to the liquid amount in the downstream tank when the pump sends out the liquid for a predetermined liquid delivery time.

2. The droplet ejection apparatus according to claim 1, wherein the hardware processor sets the predetermined liquid delivery time based on a flow rate of the pump measured in advance.

3. The droplet ejection apparatus according to claim 1, wherein,
the measurer includes a liquid level sensor configured to be capable of measuring a liquid level height of the downstream tank, and
the measurer measures a change amount in the liquid level height in the downstream tank measured by the liquid level sensor.

4. The droplet ejection apparatus according to claim 2, wherein the hardware processor sets the predetermined liquid delivery time such that a liquid level height in the downstream tank becomes a predetermined value as a result of the pump sending out the liquid.

5. The droplet ejection apparatus according to claim 2, wherein the hardware processor sets the predetermined liquid delivery time in accordance with measurement accuracy of the measurer.

6. The droplet ejection apparatus according to claim 1, wherein the hardware processor adjusts a liquid level height in the downstream tank to a predetermined value before the pump sends out the liquid for the predetermined liquid delivery time.

7. The droplet ejection apparatus according to claim 1, wherein the pump is a diaphragm pump.

8. The droplet ejection apparatus according to claim 1, wherein the hardware processor calculates a liquid level height in the downstream tank based on an average value of a measurement value of the measurer in a predetermined time.

9. A droplet ejection apparatus abnormality detecting method executed by a droplet ejection apparatus including,
a plurality of tanks that store a liquid,
a droplet ejection head that ejects droplets,
a pump that sends out the liquid stored in an upstream tank on an upstream side in a liquid delivery direction to a downstream tank on a downstream side in the liquid delivery direction,
a liquid channel that communicates the upstream tank and the downstream tank, and
a measurer that measures a value related to a liquid amount of the liquid in the downstream tank,
the method comprising:
determining whether there is an abnormality in the liquid channel,
wherein it is determined whether there is an abnormality in the liquid channel based on a change in a value related to the liquid amount in the downstream tank when the pump sends out the liquid for a predetermined liquid delivery time.

10. A non-transitory computer readable storage medium storing a program executed in a computer in a droplet ejection apparatus including,
a plurality of tanks that store a liquid,
a droplet ejection head that ejects droplets,
a pump that sends out the liquid stored in an upstream tank on an upstream side in a liquid delivery direction to a downstream tank on a downstream side in the liquid delivery direction,
a liquid channel that communicates the upstream tank and the downstream tank, and
a measurer that measures a value related to a liquid amount of the liquid in the downstream tank,
the program causing the computer to perform,
determining whether there is an abnormality in the liquid channel,
wherein it is determined whether there is an abnormality in the liquid channel based on a change in a value related to the liquid amount in the downstream tank when the pump sends out the liquid for a predetermined liquid delivery time.
